(19) United States
(12) Patent Application Publication
(10) Pub. No.: US 2009/0286409 A1
(43) Pub. Date: Nov. 19, 2009

(54) ELECTRICAL CONNECTOR HAVING A BOTTOM PLATE WITH TWO SEPARATED PARTS ASSEMBLED TO A BASE

(75) Inventors: CHIH-PI CHENG, Tu-Cheng (TW); NAN-HUNG LIN, Tu-Cheng (TW); HAO-YUN MA, Tu-Cheng (TW); CHI-NAN LIAO, Tu-Cheng (TW); LIANG-KAI LEE, Tu-Cheng (TW); CHENG-CHING CHIEN, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/468,070

(22) Filed: May 19, 2009

(30) Foreign Application Priority Data
May 19, 2008 (TW) 97208667
Jun. 3, 2008 (TW) 97120545

(51) Int. Cl. H01R 12/14

(52) U.S. Cl. 439/68

(57) ABSTRACT

An electrical connector (1) comprises a base (10) with a plurality of contacts (19) received therein, a cover (11) slidably mounted on the base (10), a protecting mechanism (12) comprises a cover plate (13) retained in the cover (11) and a bottom plate (14) retained in the base (10), a cam actuator (16) rotatably assembled to the base (10), the cover (11) and the protecting mechanism (12) for actuating the cover (11) to slid on the base (10), the bottom plate (14) comprises a first plate (142) and a second plate (141), the first plate (142) comprises a base portion (1421) and a first engaging portion (1422) extending curvedly from the end of the body portion (1421).

### BACKGROUND OF THE INVENTION

1. Field of Invention

The present invention relates to an electrical connector, and more particularly to an electrical connector having a bottom plate with two separated parts assembled to the base.

2. Description of the Prior Art

A ZIF socket is often used to mount a PGA chip onto a printed circuit board (PCB). One example of the such connectors comprises a plastic base, a plastic cover mounted on the base, a plurality of electrical contacts received in the base, a metal cover plate insert molded in the cover, a bottom plate received in the base and a cam actuator for driving the cover slide along the base. The base defines a recess for receiving the bottom plate at one end thereof, and the bottom of the recess defines a through hole. The bottom plate, the cover plate and the cover each defines a through hole in alignment with the through hole of the base.

In assembly, the cam actuator goes through the through holes of the cover, the cover plate, the bottom plate and the base, then the cover, the cover plate, the base plate and the base can be assembled together. When the cam actuator is rotated, the cover can be driven to slide along the base to make the PGA chip in contact with the contacts of the ZIF socket, then make a good electrical connection between the PGA chip and the PCB. Due to the ZIF socket becoming smaller and smaller and the number of the contacts becoming more and more, the force exerted on the cam actuator is increased. Then, the force that the bottom plate exerts on the base is accordingly increased. Because only the edge of the bottom plate engages with the base, it would be difficult to disperse the force exerted on the base, so the base is easy to be damaged.

In view of the above, a new electrical connector assembly that overcomes the above-mentioned disadvantages is desired.

### SUMMARY OF THE INVENTION

Accordingly, an object of the present invention is to provide an electrical connector that can make the force exerted on the base to disperse equably.

To fulfill the above-mentioned object, an electrical connector for using with a PGA (Pin Grid Array) chip comprises a base with a plurality of contacts received therein, a cover slidably mounted on the base, a protecting mechanism positioned between the cover and the base, and a cam actuator rotatably assembled to the base, the cover and the protecting mechanism for actuating the cover to slid on the base. The protecting mechanism comprises a cover plate retained in the cover and a bottom plate retained in the base, the bottom plate comprises a first plate and a second plate, the first plate comprises a base portion and a first engaging portion extending curvedly from the end of the body portion.

Other objects, advantages and novel features of the invention will become more apparent from the following detailed description when taken in conjunction with the accompanying drawings.

### BRIEF DESCRIPTION OF THE DRAWINGS

FIG. 1 is an exploded view of an electrical connector of a first embodiment of the present invention;

FIG. 2 is a top plane view of the base assembled with the bottom plate;

FIG. 3 is an assembled view of the electrical connector shown in FIG. 1;

FIG. 4 is an exploded view of the base plate and the base of a second embodiment of the present invention;

FIG. 5 is a top view of the base assembled with the bottom plate in FIG. 4;

FIG. 6 is an exploded view of the base plate and the base of a third embodiment of the present invention; and

FIG. 7 is a top view of the base assembled with the bottom plate in FIG. 6.

### DETAILED DESCRIPTION OF THE PREFERRED EMBODIMENT OF THE INVENTION

Reference will now be made to the drawings to describe the present invention in detail.

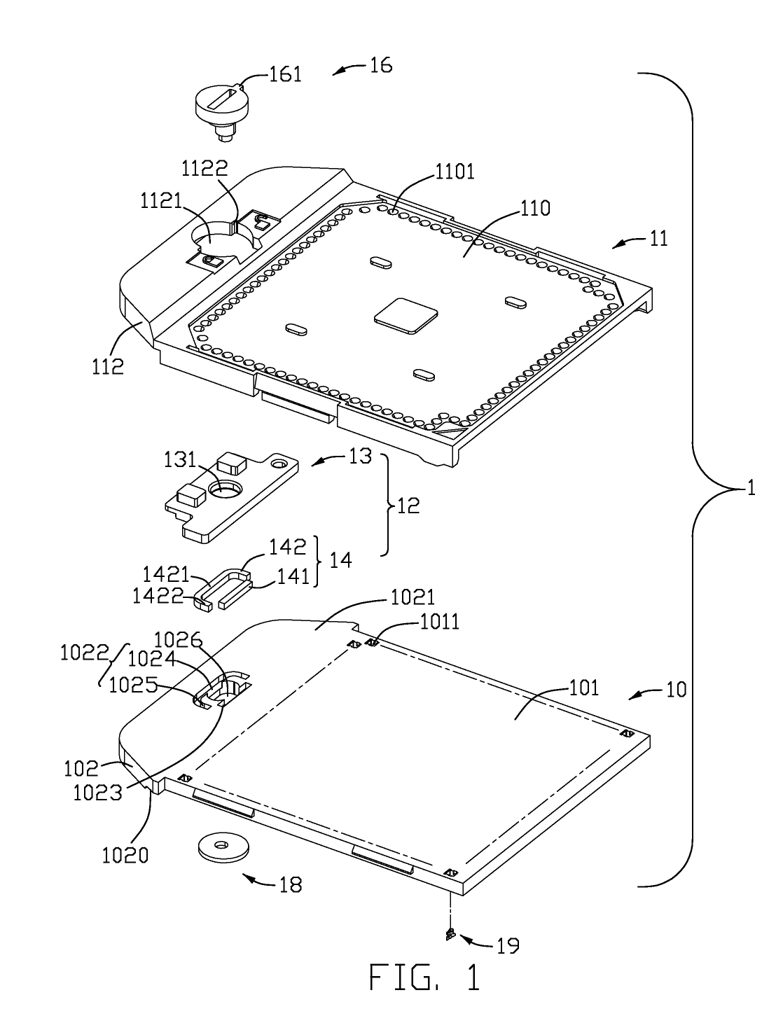

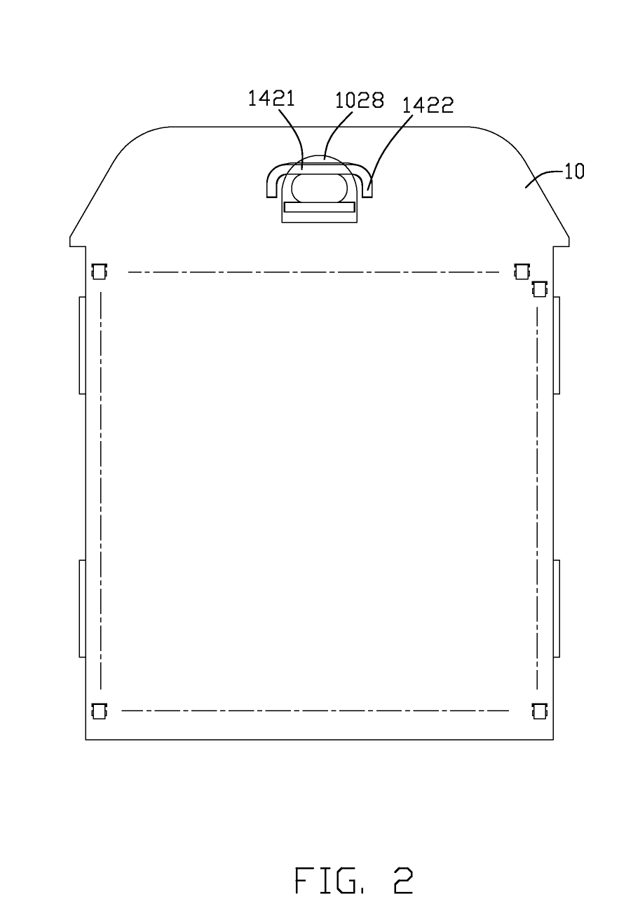

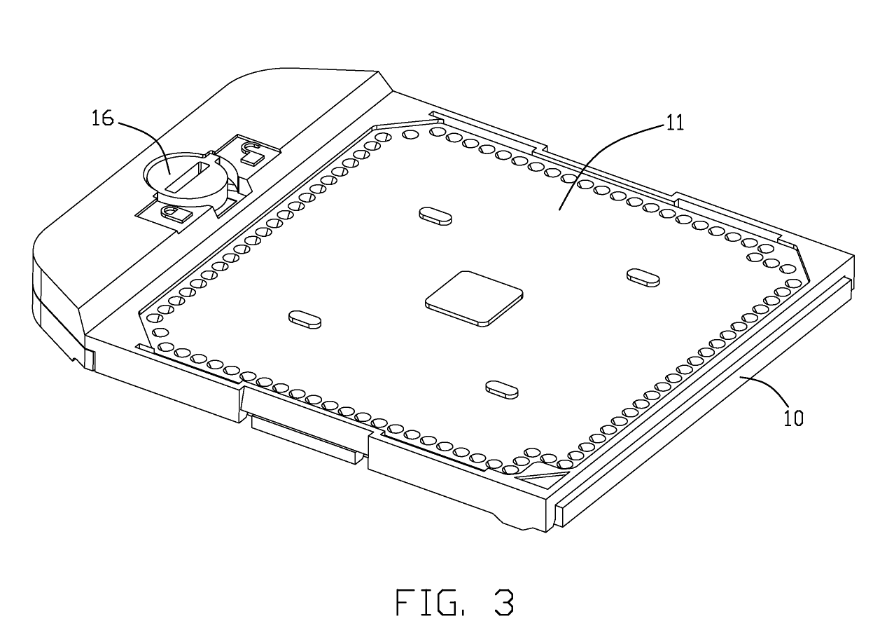

Referring to FIGS. 1 to 3, an electrical connector 1 in according with the present invention is used for electrically connecting an electronic package, such as a pin grid array (PGA) chip (not shown), with a circuit substrate, such as a printed circuit board (PCB) (not shown). The electrical connector 1 comprises an insulative base 10, a dielectric cover 11, a plurality of contacts 19, a metallic cam actuator 16, a protecting mechanism 12 and a washer 18.

The base 10 is generally in the shape of a square and comprises a body portion 101 and an extending portion 102 extending from one end of the body portion 101. The body portion 101 defines a plurality of passageways 1011 extending vertically through the body portion 101 to receive the contacts 19. The extending portion 102 comprises a bottom surface 1020 near the PCB and an upper surface 1021 opposite to the bottom surface 1020. The middle of the upper surface 1021 defines a bottom hole 1026 impenetrate to the bottom surface 1020. The middle of the bottom surface 1020 defines a recess 1028 to receive the washer 18. The extending portion 102 also defines a U-shaped groove 1022 at one side of the bottom hole 1026 and a linear shaped channel 1023 at the other side of the bottom hole 1026, the groove 1022 and the channel 1023 are connected with the bottom hole 1026, but the groove 1022, the channel 1023 and the recess 1028 are disconnected with each other. The groove 1022 comprises a first groove 1024 paralleled with the channel 1023 and a pair of second groove 1025 extending to the channel 1023 from the two end of the first groove 1024.

The cover 11 has a shape corresponding to that of the base 10 and comprises a support portion 110 and a head portion 112 extending from one end of the support portion 110. The head portion 112 is higher than the support portion 110 and defines a top hole 1121 in the middle thereof in alignment of the bottom hole 1026 of the base 10. The top hole 1121 consists of two semicircle-shaped holes of different diameters. A pair of opposite stop walls 1122 are provided at the junction of the two semicircle-shaped holes. The support portion 110 defines a plurality of passages 1101 in alignment with the passageways 1011 of the base 10.

The protecting mechanism 12 comprises a T-shaped metal cover plate 13 insert molded in the cover 11 and a metal bottom plate 14 received in the base 10. The cover plate 13 defines a through hole 131 in alignment with the top hole 1121 of the cover 11. The bottom plate 14 comprises a first plate 142 received in the groove 1022 and a second plate 141 with a linear configuration received in the channel 1023. The first plate 142 comprises a base portion 1421 with a linear configuration and a pair of first engaging portions 1422 extending curvedly and downwardly from the two end of the base portion 1421. The first engaging portion 1422 make the first plate 142 have a feature of spring, when the first plate 142 is assembled to the groove 1022, the spring feature make the first plate 142 positioned in the groove 1022 securely. The cam actuator 16 is made of several eccentric cylinders and defines a protrusion 161 extends outwardly from the top end.

In assembly, the first plate 142 is received in the groove 1022 and the second plate 141 is received in the channel 1023 of the base 10. Second, the cover 11 together with insert molded cover plate 13 is assembled onto the base 10. Successively, the cam actuator 16 is mounted onto the electrical connector 1 from the top via the top hole 1121 and then through the through hole 131 and the bottom hole 1026. The end of the cam actuator 16 is riveted with the washer 18 assembled in the recess 1028 of the base 10, whereby the cam actuator 16, the cover 11, the base 10 and the washer 18 are assembled together.

In use, rotation of the cam actuator 16 will create a driving force to move the cover 11 along the base 10, thereby making the pins (not showing) of the PGA chip engage with the contacts 19 in the passageways 1011. To dismount the electrical connector 1, the cam actuator 16 is rotated in an opposite direction, thereby can disengage the pins of the PGA chip from the contacts 19 of the electrical connector 1 and allow the PGA chip to be removed from the cover 11.

There is a little gap between the base portion 1421 of the first plate 142 and the sidewall of the first groove 1024, so the major portion of the force that the first plate 142 exerted on the base 10 comes from the first engaging portions 1422. At the same time, the first engaging portions 1422 are located beyond the region of the recess 1028 in the horizontal direction. It is to say, the force is exerted on a thinner place of the base 10, which can prevent the damage of the base 10 due to the great force exerted by the first plate 142.

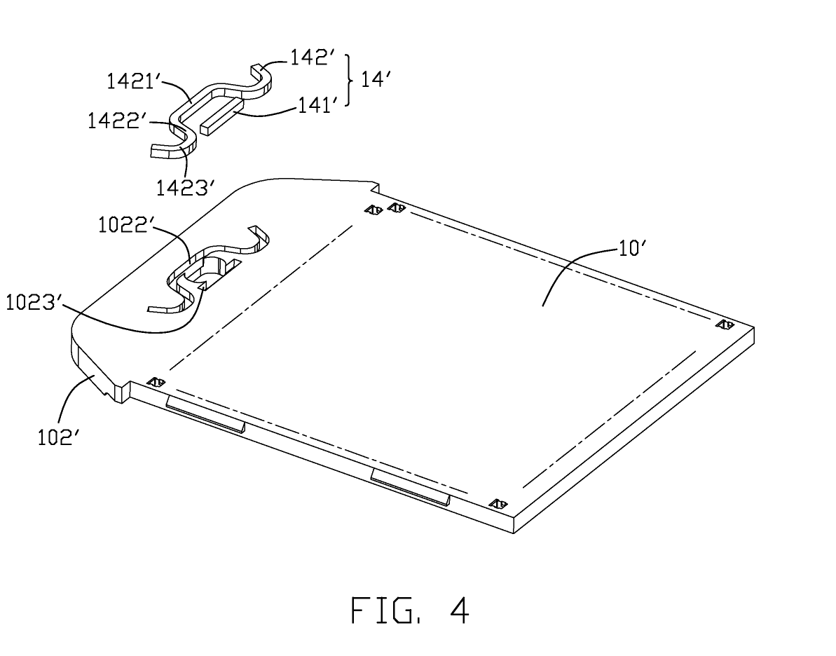

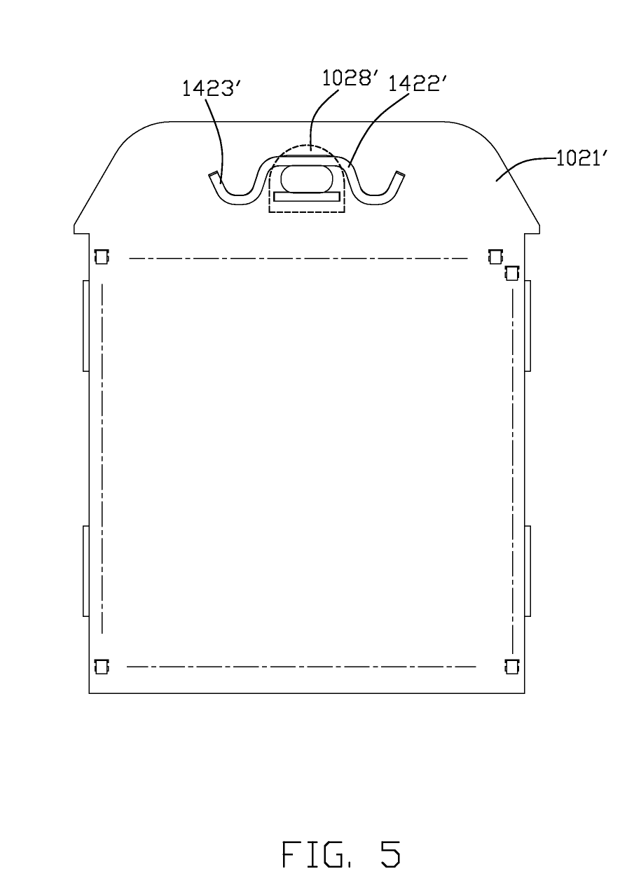

Referring to FIGS. 4 to 5, showing a second embodiment of the present invention, which is similar to the first embodiment except the first plate 142′ thereof further comprises a pair of second engaging portions 1423′ extending curvedly and upwardly from the end of the two first engaging portions 1422′. When the first plate 142′ is assembled into the groove 1022′, the first engaging portion 1422′ and the second engaging portion 1423′ are both located beyond the region of the recess 1028′ in the horizontal direction. It is to say, the force is exerted on a thinner place of the base 10′, which can prevent the damage of the base 10′ due to the great force exerted by the first plate 142′.

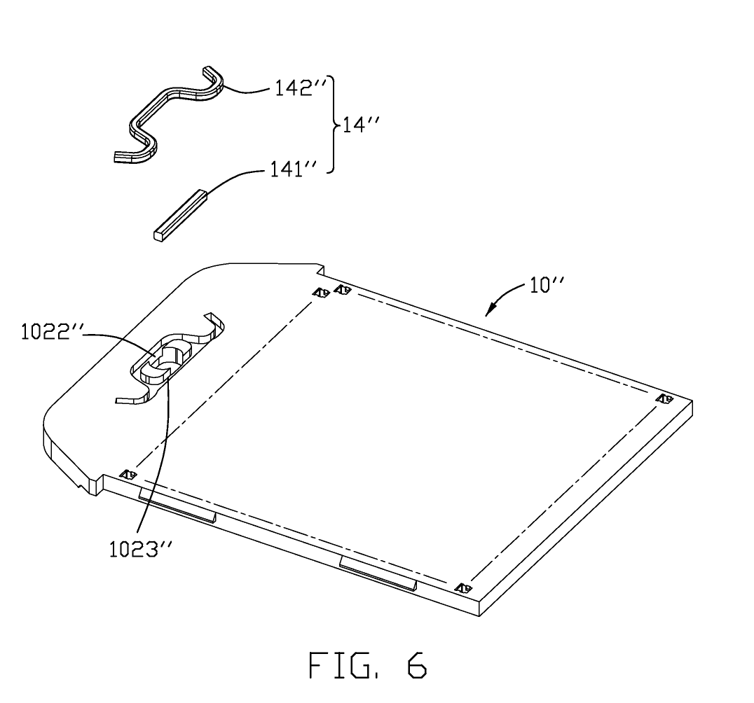

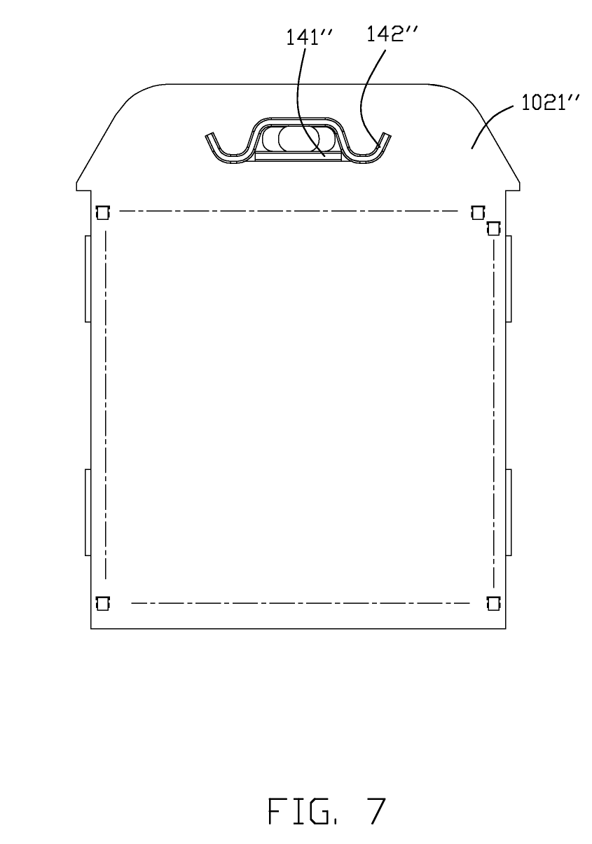

Referring to FIGS. 6 to 7, showing a third embodiment of the present invention, the difference between the second and third embodiment is the channel 1023″ is connected with the groove 1022′. When the first plate 142′ is assembled into the groove 1022″ and the second plate 141″ is assembled into the channel 1023′, the second plate 141″ will engage with the first plate 142″, which can enhance the intensity of the bottom plate 14″.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for using with a PGA (Pin Grid Array) chip, comprising:
a base with a plurality of contacts received therein;
a cover slidably mounted on the base;
a protecting mechanism positioned between the cover and the base and comprising a cover plate retained in the cover and a bottom plate retained in the base; and
a cam actuator rotatably assembled to the base and having a portion abutting against to the cover;
wherein the bottom plate comprises a first plate and a second plate, and the first plate comprises a base portion and a first engaging portion extending curvedly from the base portion.

2. The electrical connector as claimed in claim 1, wherein the base portion and the second plate are configured to a linear shape.

3. The electrical connector as claimed in claim 1, wherein the base is generally in the shape of a square and comprises a body portion and an extending portion extending from one end of the body portion.

4. The electrical connector as claimed in claim 3, wherein the extending portion defines a bottom surface and an upper surface opposite to the bottom surface, and the bottom surface defines a recess to receive a washer which assembled on the cam actuator.

5. The electrical connector as claimed in claim 4, wherein the middle of the upper surface defines a bottom hole impenetrate to the bottom surface, a groove at one side of the bottom hole to receive the first plate and a channel at the other side of the bottom hole to receive the second plate.

6. The electrical connector as claimed in claim 4, wherein the first plate further comprises a second engaging portion extending outwardly and curvedly from the first engaging portion.

7. The electrical connector as claimed in claim 6, wherein the first engaging portion and the second engaging portion are located beyond the region of the recess in the horizontal direction.

8. The electrical connector as claimed in claim 5, wherein the groove and the channel are connected with the bottom hole, and the recess is disconnected with the groove and the channel.

9. The electrical connector as claimed in claim 8, wherein the groove is connected with the channel and the first plate is connected with the second plate.

10. An electrical connector for using with a PGA (Pin Grid Array) chip, comprising:
a base with a plurality of contacts received therein and defining a bottom hole at one end thereof, an upper surface of the base defining a groove at one side of the bottom hole and a channel at the other side of the bottom hole, an opposite bottom surface of the base defining a recess, the groove comprising a first groove and a second groove extending to the channel curvedly from the end of the first groove;
a cover slidably mounted on the base and defining a top hole in alignment of the bottom hole of the base;
a cover plate retained in the cover;
a bottom plate retained in the base and comprising a first plate positioned in the groove of the base and a second plate positioned in the channel of the base;
a cam actuator extending through the top hole and the bottom hole for actuating the cover to slide on the base; and
a washer positioned in the recess and assembled to the end of the cam actuator for securely assembled the cam actuator on the base.

11. The electrical connector as claimed in claim 10, wherein the first plate comprises a base portion and a first engaging portion extending curvedly from the base portion.

12. The electrical connector as claimed in claim 11, wherein the first plate further comprises a second engaging portion extending curvedly and outwardly from the first engaging portion.

13. The electrical connector as claimed in claim 10, wherein the groove is connected with the channel and the first plate is connected with the second plate.

14. An electrical connector comprising:
an insulative base defining a first hole and a groove communicatively beside the first hole;
an insulative cover mounted upon the base and moveable relative to the base in a front-to-back direction, said cover defining a second hole;
a protection mechanism have a metallic cover part embedded in the cover and defining a third hole, and a metallic bottom part received in the groove; and
a cam actuator having different sections with different diameters in a vertical direction and respectively received in the corresponding first, second and third holes, respectively; wherein
the bottom part is configured to provide resiliency thereof during engagement with the corresponding section in a radial direction perpendicular to an axial direction of said cam actuator.
